(19) United States
(12) Patent Application Publication
(10) Pub. No.: US 2006/0122920 A1
(43) Pub. Date: Jun. 8, 2006

(54) System, method, and apparatus for invoicing

(75) Inventors: Wealthy Desai, Atlanta, GA (US); Glenn Conrad, Lawrenceville, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(73) Assignee: BellSouth Intellectual Property Corporation

(21) Appl. No.: 11/003,776

(22) Filed: Dec. 3, 2004

(51) Int. Cl. G06F 17/60

(52) U.S. Cl. 705/34

(57) ABSTRACT

A method for providing an invoice for publishing an image is disclosed. The method includes receiving an image to be published from the image provider. Also included is receiving an electronic invoice in a content-descriptive, cross-platform format, where the invoice is for publishing the image. The electronic invoice is used to generate another electronic invoice that is transmitted to the image provider. Along with this electronic invoice, the image may also be transmitted to the image provider.

### TECHNICAL FIELD

The present disclosure is generally related to invoicing, and more particularly, to invoicing related to image publishing.

### BACKGROUND OF THE DISCLOSURE

Placing an advertisement in a telephone directory has been traditionally carried out using a customer marketing representative (CMR) company that acts as an intermediary between an advertiser and a telephone company. As a part of its services, the CMR company markets the advertisement facilities provided by the telephone company, collects an advertisement from the advertiser, and arranges for the advertisement to be delivered to a publishing unit of the telephone company. The publishing unit of the telephone company generates what is known in the industry as a “tear-page,” which is an image of a page containing the advertisement as it would appear when eventually printed in the telephone directory. A tear-page is typically intended for proof-reading and approval by the advertiser prior to publication of the telephone directory. The publishing unit provides this tear-page to the billing department of the telephone company, together with billing information where appropriate.

The billing department prepares an invoice which includes a commission amount payable by the phone company to the CMR company and transmits this invoice, together with the tear-page, to the CMR company. The invoice and tear-page are transmitted to the CMR company via conventional mail, or alternatively, via a telephone company website that a CMR company employee is authorized to access for downloading and printing the two documents. Upon receipt of these documents, the CMR company generates its own invoice, by omitting the commission amount, for example, before delivering the CMR company invoice and the tear-page to the advertiser.

The traditional system described above suffers from certain disadvantages, such as labor-intensive cost and low efficiency. A CMR company that handles a large volume of invoices has to provide personnel to process the invoices from the phone company. In the case of conventional mail, this processing involves manual labor, such as receiving and sorting of invoices and tear-pages. In the case of web access, this processing requires logging onto the website, viewing the documents, downloading the documents, and further processing the documents. One example of such further processing relates to translating a downloaded document, which may be formatted in Adobe® Acrobat® pdf (read-only) as per the desirability of this format by the telephone company, to a document of a second format that is more suitable for editing by the CMR company. The second document may be formatted, for example, in Microsoft® Excel where data entries can be manipulated as is known in the art. This second document may then be translated into a third format, such as for example, Microsoft® Word or Adobe® Acrobat® pdf, before being transmitted to the advertiser. Translating between certain formats such as pdf and Microsoft®Excel is time-consuming, cumbersome, expensive and inefficient.

Thus, a heretofore unaddressed need exists in the industry to address the aforementioned deficiencies and inadequacies.

### SUMMARY OF THE DISCLOSURE

One embodiment, among others, of the present disclosure includes a method wherein an image to be published is received from an image provider. Also received is a first electronic invoice in a content-descriptive, cross-platform format, for publishing of the image. The first electronic invoice is used to generate a second electronic invoice that is transmitted to the image provider together with, optionally, the image.

Other devices, systems, methods, and/or computer program products according to exemplary embodiments will be or become apparent to one with skill in the art upon examination of the following drawings and detailed description. It is intended that all such additional systems, methods, features, and advantages be included within this description, and the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an exemplary embodiment of the invoicing system that includes a telephone company, a customer marketing representative (CMR) company, and an advertiser interconnected to one another through the Internet.

FIG. 2 is a block diagram of an invoice processing server located at the telephone company of FIG. 1.

FIG. 3 is a block diagram of an invoice processing client located at the CMR company of FIG. 1.

FIG. 4 shows a flowchart of an exemplary method of generating and processing an invoice at the telephone company of FIG. 1.

FIG. 5 shows a flowchart of an exemplary method of receiving and processing an invoice at the CMR company of FIG. 1.

### DETAILED DESCRIPTION

While the description below refers to certain exemplary embodiments, it is to be understood that the disclosure is not limited to these particular embodiments. On the contrary, the intent is to cover all alternatives, modifications and equivalents included within the spirit and scope of the disclosure. Also, the terminology used herein is for the purpose of description and not of limitation. As one example among many, while reference is made to the term “e-mail” it will be understood that various other methods may be used for communication. For example, instant messaging (IM), e-fax, file transfer protocol (ftp) access, and web access may be used to electronically transfer information from one computer to another. Also, while computers and other items are shown housed inside certain locations such as the CMR company, it will be understood that this is done merely for explanation purposes, and in alternative embodiments items such as the illustrated desktop computers are replaced by portable computers that are not confined to certain premises.

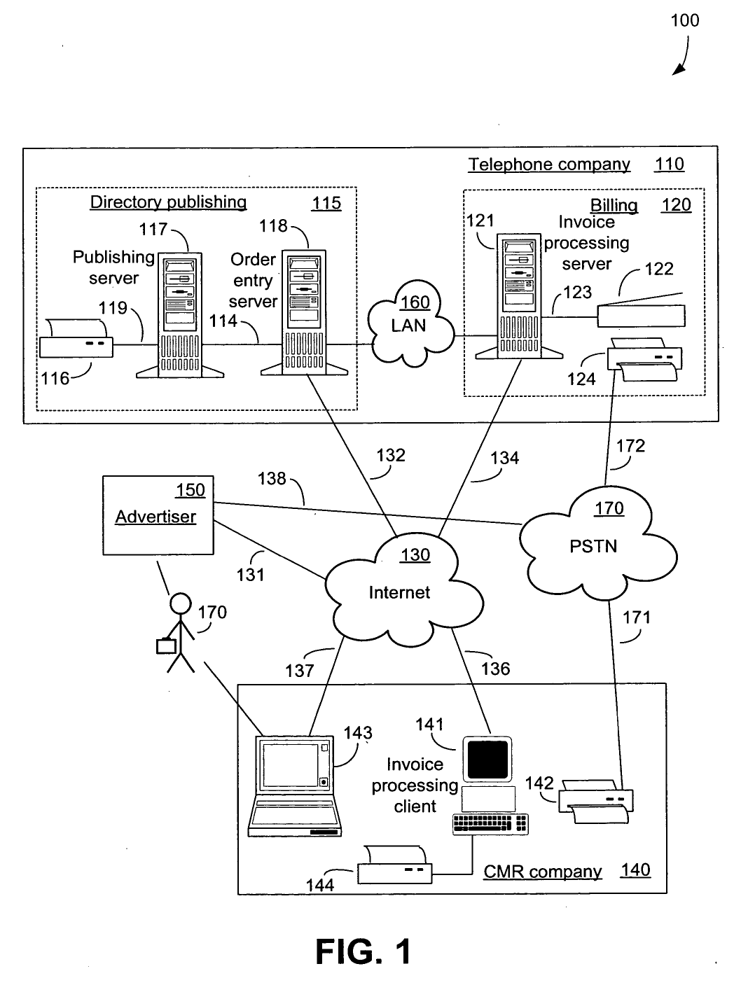

Attention is now drawn to FIG. 1, which illustrates one among many. exemplary embodiments of an invoicing system. Invoicing system 100 includes a telephone company 110, a customer marketing representative (CMR) company 140, and an advertiser 150 interconnected to one another through a network, such as the Internet 130. Telephone company 110 has a directory publishing division 115 and an advertisement billing division 120. Although shown as being entities within the telephone company 110, it should be appreciated that the directory publishing division 115 and/or the billing division 120 may be entities outside the telephone company 110 but associated with it.

Directory publishing division 115 uses a computer network, exemplary elements of which are shown in FIG. 1. Order entry server 118 is connected to Internet 130 through link 132. Order entry server 118 is also connected to publishing server 117 through link 114, which may be part of a local area network inside directory publishing division 115. Publishing server 117 is in turn connected to a printing device 116 through link 119, which may also be a part of the LAN inside directory publishing division 115. Order entry server 118 is further connected through a LAN 160 to invoice processing server 121 that is housed in the advertisement billing division 120. The billing division may be connected to the Internet 130 via a link 134. As an alternative to using LAN 160 for transmitting electronic data from order entry server 115 to invoice processing server 121, Internet 130, together with links 132 and 134, may also be used.

Invoice processing server 121 is connected to scanner 122 through link 123. It will be understood that in one or more embodiments, links 114, 119, and 123 are a part of LAN 160, which is a company-wide LAN of telephone company 110. Facsimile 124 is connected to the public switched telephone network (PSTN) 170 through link 172, which is a telephone line associated with PSTN 170. Also connected to PSTN 170 via link 138 is a facsimile (not shown) of advertiser 150, whereby this facsimile is communicatively coupled to facsimile 142 in CMR company 140 and, if so desired, to facsimile 124 in advertisement billing division 120.

CMR company 140 houses an invoice processing client 141 that is communicatively coupled to invoice processing server 121 through Internet 130 and links 136 and 134. Facsimile 142 is communicatively coupled to facsimile 124 through links 171, 172, and PSTN 170. Order entry computer 143 is configured to accept manual order entry from a CMR representative 170, and is linked to Internet 130 through link 137.

It will be understood that links such as links 131, 132, 134, 135, 136, and 137 may be implemented as high-speed Internet links using technologies such as wire-line, wireless, and fiber. Additionally, in other embodiments, Internet 130 may be replaced by networks such as a corporate wide-area network (WAN) and a network comprising point-to-point high-speed links.

Operation of invoicing system 100 will now be explained. CMR representative 170 visits advertiser 150 and obtains an order for placement of an advertisement in a telephone directory of telephone company 110. According to an exemplary embodiment, advertiser 150 is one of multiple advertisers (not shown) that place advertisement orders through CMR company 140. Once the order is obtained from advertiser 150, representative 170 manually enters the order into order entry computer 143, which is for example, a laptop computer that representative 170 carries with him when visiting advertiser 150. Representative 170 uses his laptop computer to connect into Internet 130 using link 137, which is a wireless link in one embodiment.

In an alternative embodiment, advertiser 150 directly enters the order for placement of the advertisement through link 131 that connects a computing device (not shown) of advertiser 150 into Internet 130. This direct order is then routed to order entry computer 143 via link 137. In this alternative embodiment, order entry computer 143 is a desktop computer that is associated with and may be located inside the premises of CMR company 140.

The entered order is transmitted from order entry computer 143 to order entry server 118 located in the directory publishing division 115 of telephone company 110.

Order entry server 118 interacts with publishing server 117, which generates an electronic image of a tear-page containing the advertisement. Publishing server 117 may be further configured to produce a hard-copy of the tear-page using printing device 116. Publishing server 117 then transmits information related to the placement of the advertisement to invoice processing server 121. Such information may include one or more of the following: invoicing data, electronic image of the tear-page, advertisement-placement data, and CMR company-related information. When the tear-page has been produced as a hard-copy, the hard-copy is transferred from directory publishing division 115 to advertisement billing division 120, using, for example, telephone company personnel or the LAN 160.

Upon receipt of the information, invoice processing server 121 generates an electronic invoice formatted in an electronic format, such as in extensible mark-up language (XML), that is recognizable and editable by the CMR company 140. It should be appreciated that the electronic invoice may be formatted in other content-descriptive, cross-platform electronic formats, e.g., other mark-up language formats, structured formats, and data tagging formats.

It will be understood that the term “electronic invoice” generally refers to information that is generated, stored, or processed using electronic devices, such as for example, but not limited to, computers, scanners, and facsimile machines. In one embodiment, the electronic invoice contains invoicing information solely relating to advertiser 150. In an alternative embodiment, the electronic invoice contains cumulative invoicing information relating to multiple advertisers, including advertiser 150, that are advertisement clients of CMR company 140. Some examples of invoicing information include: directory number, directory issue date, client number, gross amount, adjustment amount, tax amount, CMR commission amount, and net amount. In some cases, invoicing information provides a further break-down wherein details related to individual advertisements are provided. Such details include, for example, item code, gross amount for individual advertisements, and advertising placement data such as white pages, yellow pages, and directory section (hospital equipment, hardware, computers etc.) where each advertisement has been placed.

The electronic invoice generated by invoice processing server 121 is transmitted to invoice processing client 141 of CMR company 140. As the invoice is formatted in XML, in this exemplary embodiment, CMR company personnel can import the invoicing data directly into any compatible format that is preferred for their use, consequently avoiding the need to have a specified program to receive and process in any one particular format that the telephone company opts to use. For example, if a telephone company opted for security reasons, to use a company-proprietary format, CMR company 140 would be compelled to use a specified program of this same format solely for the purpose of receiving the electronic invoice.

Such a limitation is eliminated by using XML, which is a widely used standard of the world-wide-web consortium (w3c) that facilitates the interchange of data between computer applications. XML uses markup codes (tags) together with a file referred to as a document type definition (DCD) file. The DCD file defines the elements and data structure contained in an XML document. A computer program can automatically extract data from an XML document using an associated DCD as a guide.

It will be understood that XML is being used in this disclosure merely for purposes of explanation, and that other alternative formats will generally involve the use of markup tags and standardized rules for adding structure to any form of data that is to be transmitted from one point to another.

Advertisement billing division 120 also transmits tear-page information to CMR company 140. This transmission is carried out in several alternative ways. In a first embodiment, an electronic version of the tear-page is transferred from invoice processing server 121 to invoice processing client 141 through Internet 130, using processes such as website access, e-mail, ftp etc. In a second embodiment, a hard-copy of the tear-page is faxed from facsimile 124 to facsimile 142. CMR company 140 forwards the tear-page to advertiser 150 either as an electronic file or as a hardcopy, or both. This action is also carried out in a manner as explained above for transferring the tear-page from the telephone company 110 to CMR company 140.

The CMR company uses the imported invoicing data that relates to advertiser 150 to generate a CMR company invoice that is then forwarded to advertiser 150. According to an exemplary embodiment, this invoice will not include the commission amount paid by telephone company 110 to CMR company 140. Also, CMR company 110 may choose to amend the invoicing amount by marking-up or reducing the amount. This invoice uses any format chosen by CMR company 110 to transfer invoicing information to advertiser 150. Such formats include, for example, XML, Microsoft® Word and Adobe® Acrobat® pdf.

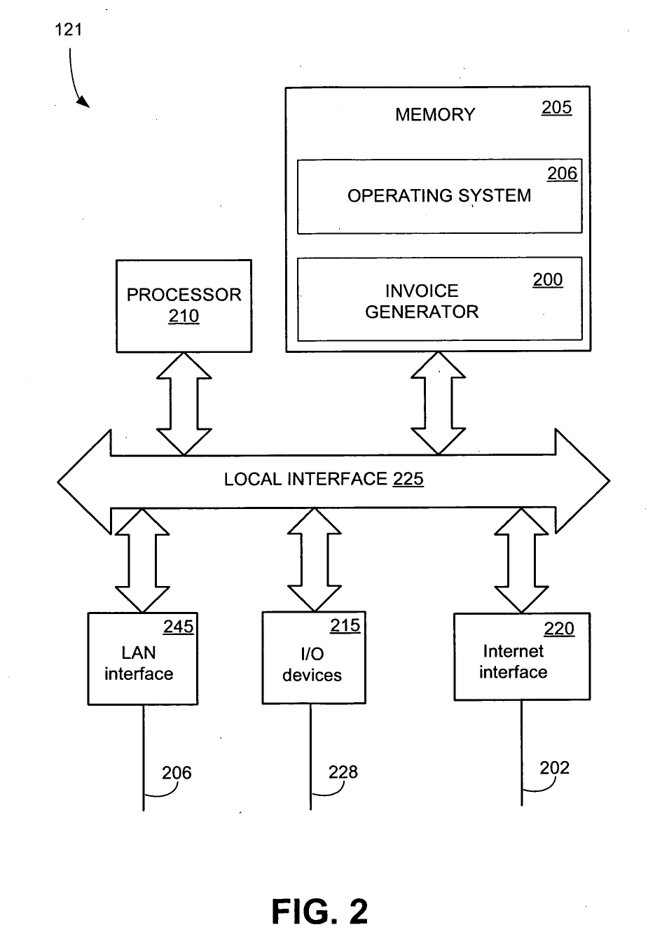

Attention is now drawn to FIG. 2, which is a block diagram of invoice processing server 121 located in advertisement billing division 120 of telephone company 110 according to an exemplary embodiment. According to one embodiment, in terms of hardware architecture, invoice processing server 121 includes a processor 210, memory 205, a LAN interface 245, an Internet interface 220, and one or more input/output (I/O) devices 215 (or peripherals) that are communicatively coupled via a local interface 225.

The local interface 225 comprises one or more buses or other wired or wireless connections, as is known in the art. In some embodiments, the local interface 225 includes additional elements, which are omitted for simplicity, such as controllers, buffers (caches), drivers, repeaters, and receivers, to enable communications. Further, the local interface includes address, control, and data connections to enable appropriate communications among the aforementioned components.

The processor 210 is a hardware device for executing software, particularly that stored in memory 205. The processor 210, in one embodiment among many, is a custom-made or commercially available processor, a central processing unit (CPU), an auxiliary processor among several processors associated with the invoice processing server 121, a semiconductor based microprocessor (in the form of a microchip or chip set), a macroprocessor, or generally any device for executing software instructions.

The memory 205 includes any one or combination of volatile memory elements (e.g., random access memory (RAM, such as DRAM, SRAM, SDRAM, etc.) and nonvolatile memory elements (e.g., ROM, hard drive, tape, CDROM, etc.). Moreover, in alternative embodiments, memory 205 incorporates electronic, magnetic, optical, and other types of storage media. Note that the memory 205 can have a distributed architecture, where various components are situated remote from one another, but can be accessed by the processor 210.

The software in memory 205 includes one or more separate programs, each of which comprises an ordered listing of executable instructions for implementing logical functions. In the example of FIG. 2, the software in the memory 205 includes an invoice generator 200 together with and a suitable operating system (OS) 206. One example, among many, of an OS located in invoice processing server 121, is a Microsoft® Windows system, such as Windows XP®, Windows NT®, etc. Persons of ordinary skill in the art will understand that there are many alternative hardware and software platforms that can be used to implement invoice processing server 121. The operating system 206 essentially controls the execution of computer programs such as invoice generator 200.

In one embodiment among many, the invoice generator 200 is implemented using logic incorporated in programs, such as a source program, executable program (object code), script, or any other entity comprising a set of instructions to be performed. When a source program, then the program needs to be translated via a compiler, assembler, interpreter, or the like, which may or may not be included within the memory 205, so as to operate properly in connection with the OS 206. Furthermore, the invoice generator 200 is written as (a) an object oriented programming language, which has classes of data and methods, or (b) a procedure programming language, which has routines, subroutines, and functions, for example but not limited to, XML, C, C++, Pascal, Basic, Fortran, Cobol, Perl, Java, and Ada.

The I/O devices 215 include input devices, for example but not limited to, a keyboard, mouse, scanner, microphone, etc. Furthermore, the I/O devices 215 may also include output devices, for example but not limited to, a printer. Finally, the I/O devices 215 further includes devices that communicate both inputs and outputs, for instance but not limited to, a modulator/demodulator (modem; for accessing another device, system, or network), a radio frequency (RF) or other transceiver, a telephonic interface, a bridge, a router, etc.

If the invoice processing server 121 is a PC, workstation, or the like, the software in the memory 205 further includes, in one embodiment, a basic input output system (BIOS) (omitted for simplicity). The BIOS is a set of essential software routines that initialize and test hardware at startup, start the OS 206, and support the transfer of data among the hardware devices. The BIOS is stored in ROM so that the BIOS can be executed when the invoice processing server 121 is activated.

When the invoice processing server 121 is in operation, the processor 210 is configured to execute software stored within the memory 205, to communicate data to and from the memory 205, and to generally control operations of the invoice processing server 121 pursuant to the software. The invoice generator 200 and OS 206, in whole or in part, but typically the latter, are read by the processor 210, perhaps buffered within the processor 210, and then executed.

When the invoice generator 200 is implemented in software, as is shown in FIG. 2, it should be noted that the invoice generator 200 is stored on any computer readable medium for use by or in connection with any computer related system or method. For example, in one of several embodiments, the invoice generator 200 is a computer program or script that runs on a stand-alone server, a network server, or on one or more computers that are part of a network.

In the context of this document, a computer readable medium is an electronic, magnetic, optical, or other physical device or means that can contain or store a computer program for use by or in connection with a computer related system or method. The invoice generator 200 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the invoice generator 200 is implemented using hardware logic, the invoice generator 200 is implemented with any or a combination of the following technologies, which are each well known in the art: a discrete logic circuit(s) having logic gates for implementing logic functions upon data signals, an application specific integrated circuit (ASIC) having appropriate combinatorial logic gates, a programmable gate array(s) (PGA), a field programmable gate array (FPGA), etc. The hardware can be housed in a stand-alone computer or in one or more computers of a network.

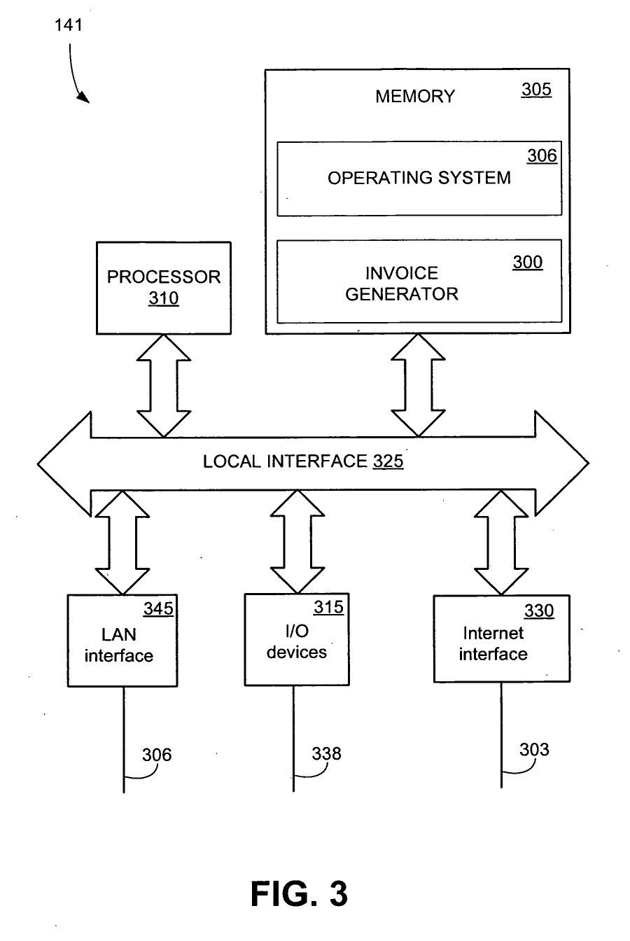

FIG. 3 shows a block diagram of invoice processing client 141 located in CMR company 140. Persons of ordinary skill in the art will understand the structure and operation of invoice processing client 141 by referring to the explanation provided above with reference to invoice processing server 121. In the interests of brevity, this explanation will not be repeated herein.

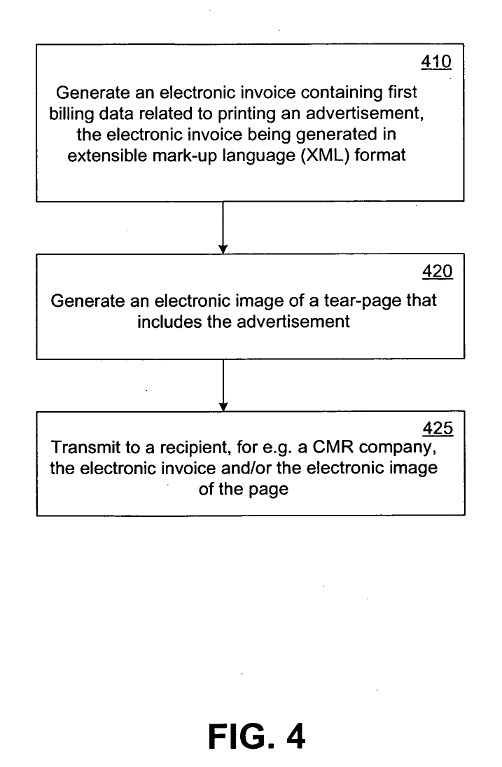

FIG. 4 is a flowchart of an exemplary method of generating and processing an invoice at the telephone company 110 of FIG. 1. In block 410, an electronic invoice is generated using XML format. The electronic invoice contains billing data related to printing an advertisement for advertiser 150. In block 420, an electronic image of a tear-page containing the advertisement is generated. In one embodiment, this electronic image is generated in publishing server 117 and transferred to invoice processing server 121 through LAN 160. In block 425, the electronic invoice is transmitted to a recipient, which, in this exemplary embodiment, is CMR company 140. Also transmitted to the recipient is the electronic image of the tear-page. It will be understood that the electronic tear-page may be transmitted together with the electronic invoice at the same time, for example, through web-access by an employee of CMR company 140 who is authorized to access these documents from a web-enabled invoice processing server 121. Alternatively, these two documents may be transmitted at different times using different electronic transfer methods. In other alternative embodiments, the tear-page is transmitted to the CMR company 140 in hard-copy format, using for example, a facsimile transmission or conventional mail.

It will be also understood that the XML formatted electronic invoice and if so desired, the tear page, can be transmitted to a recipient other than CMR company 140. For example, a first such recipient is advertiser 150 of FIG. 1, while a second such recipient is a document processing center (not shown).

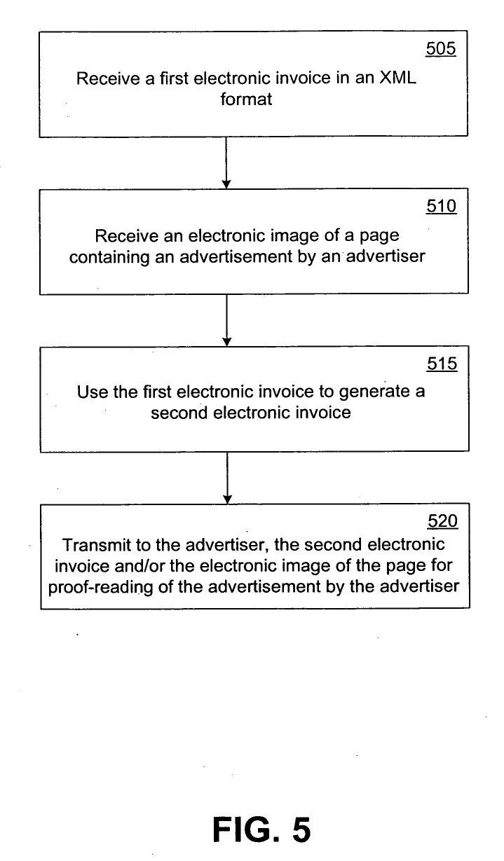

FIG. 5 is a flowchart of an exemplary method of receiving and processing an XML-formatted invoice. FIG. 1 will be again used for explanation purposes. In block 505, a recipient, such as CMR company 140 receives an electronic invoice formatted in XML. In block 510, the recipient further receives an electronic image of a tear-page. The electronic image of the tear-page may be received at the same time as the electronic invoice, or alternatively, at different times. In block 515, the data contained in the electronic invoice is used to generate a second invoice, for example a CMR company invoice to advertiser 150. As explained above, certain data contained in the received electronic invoice may be eliminated, and additional data provided, during generation of the second invoice.

In block 520, the second electronic invoice is transmitted to a recipient, which in this exemplary embodiment, is advertiser 150. Also transmitted to the recipient, is the electronic image of the tear-page. It will be understood that the electronic tear-page may be transmitted together with the electronic invoice at the same time, for example, through web-access by an employee of advertiser 150 who is authorized to access these documents from a web-enabled invoice processing client 141. Alternatively, these two documents may be transmitted at different times using different electronic transfer methods. In other alternative embodiments, the tear-page and, if so desired, the second electronic invoice, is transmitted to the advertiser 150 in hard-copy format, using for example, a facsimile transmission or conventional mail. The hardcopy of the second electronic invoice is generated by invoice processing client 141 using printer 144.

The tear-page is used by advertiser 150 for purposes such as proof-reading of the advertisement, while the electronic invoice is used to provide payment to the CMR company 140 towards service rendered for placing the advertisement in the directory of telephone company 110.

It should be emphasized that the above-described embodiments of the present disclosure, particularly, any “preferred” and “exemplary” embodiments, are merely possible examples of implementations, merely set forth for a clear understanding of the principles of the disclosure. Many variations and modifications may be made to the above-described embodiment(s) of the disclosure without departing substantially from the principles of the disclosure. All such modifications and variations are intended to be included herein within the scope of this disclosure and the present disclosure and protected by the following claims.

What is claimed is:

1. A method for providing an invoice for publishing an image, comprising:
receiving an image to be published from an image provider;
receiving a first electronic invoice in a content-descriptive, cross-platform format, wherein the invoice is for publishing the image;
using the first electronic invoice to generate a second electronic invoice; and
transmitting to the image provider at least one of the second electronic invoice and the image.

2. The method of claim 1, wherein the image is an advertisement.

3. The method of claim 1, wherein the image includes a tear page of a telephone directory.

4. The method of claim 1, wherein the content-descriptive, cross-platform format is an extensible mark-up language (XML) format.

5. The method of claim 1, wherein generating the second electronic invoice comprises: generating the second electronic invoice in at least one of a) an XML format and b) a portable document format (pdf).

6. The method of claim 1, wherein generating the second electronic invoice further comprises: editing billing data contained in the first electronic invoice.

7. The method of claim 6, wherein editing the billing data comprises omitting a commission amount.

8. The method of claim 1, wherein receiving the image comprises: receiving the image in at least one of a) an electronic format using a computer, and b) a hardcopy format using a postal system.

9. The method of claim 8, wherein the electronic format is pdf.

10. The method of claim 1, wherein transmitting to the image provider comprises at least one of an electronic transmission and a hardcopy transmission.

11. The method of claim 10, wherein the electronic transmission comprises at least one of an e-mail transmission and an Internet communication.

12. The method of claim 10, wherein the hardcopy transmission comprises:
producing a hardcopy of the second electronic invoice;
producing a hardcopy of the page; and
transmitting the two hardcopies through at least one of a facsimile transmission and a mailing through a postal service.

13. The method of claim 1, wherein the first electronic invoice includes at least one of a client number, a directory number, a gross amount, a commission amount, and a net amount.

14. The method of claim 1, wherein the second electronic invoice includes at least one of a directory number and a net amount.

15. An invoicing system, comprising:
logic configured to receive from an image provider, an image to be published;
logic configured to receive a first electronic invoice in a content-descriptive, cross-platform format, wherein the invoice is for publishing the image;
logic configured to use the first electronic invoice to generate a second electronic invoice; and
logic configured to transmit to the image provider at least one of the second electronic invoice and the image.

16. The invoicing system of claim 15, wherein the content-descriptive, cross-platform format is an extensible mark-up language (XML) format.

17. The invoicing system of claim 15, wherein logic configured to transmit to the image provider comprises:
logic configured to produce a hardcopy of the second electronic invoice;
logic configured to produce a hardcopy of the image; and
logic configured to transmit the two hardcopies through at least one of a facsimile transmission and a mailing through a postal service.

18. The invoicing system of claim 15, wherein the second electronic invoice is generated in at least one of a) an XML format and b) a portable document format (pdf).

19. The invoicing system of claim 15, wherein the image from the image provider is received in a portable document format (pdf).

20. An apparatus comprising:
means for receiving an image to be published from an image provider;
means for receiving a first electronic invoice in a content-descriptive, cross-platform format, wherein the invoice is for publishing the image;
means for using the first electronic invoice to generate a second electronic invoice; and
means for transmitting to the image provider at least one of the second electronic invoice and the image.

21. The apparatus of claim 20, wherein the image is an advertisement.

22. The apparatus of claim 20, wherein means for transmitting to the image provider comprises means for at least one of an electronic transmission and a hardcopy transmission.

23. The apparatus of claim 22, wherein means for transmitting is one of a facsimile and a mailing through a postal service.

24. The apparatus of claim 20, wherein the content-descriptive, cross-platform format is an extensible mark-up language (XML) format.
